(19) United States
(12) Patent Application Publication
(10) Pub. No.: US 2003/0042337 A1
(43) Pub. Date: Mar. 6, 2003

(54) Connector for a faucet

(76) Inventors: Tsang-Hua Liang, Changhua Hsien (TW); Tsang-Fu Liang, Changhua Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/942,714

(22) Filed: Aug. 31, 2001

(51) Int. Cl. B05B 7/02

(52) U.S. Cl. 239/575; 239/526; 239/428.5

(57) ABSTRACT

A connector for a faucet (20) is constructed of a faucet-connecting portion (11) and a tube-connecting portion (13). The faucet-connecting portion (11) further has a thread defined in an inner or outer periphery of the faucet-connection (11) to threadingly combine with the faucet (20). The tube-connecting portion (13) is adapted to connect with a quick-release hose (30) having a spraying device. Therefore, the connector (10) communicate between the faucet (20) and the quick-release hose (30) in an easy manner.

### BACKGROUND OF THE INVENTION

1. Field of the Invention

The present invention relates to a connector for a faucet, and more particularly to a connector that easily and rapidly combines with a faucet by screwing.

2. Description of Related Art

With reference to FIG. 4, although kitchen or bathroom faucets at the present have various aesthetic shapes however, most of the faucets have no joint for connecting with a hose. A faucet (50) shown in FIG. 4 has a spout (51) and a thread (52) defined in an inner periphery of the spout (51). An aerator (60) has a threaded outside surface corresponding to the thread (52) so that the aerator (60) is detachably secured in the spout (51).

According to the above description, the kitchen or bathroom faucet (50) can not provide water to a further place except a sink where the faucet (50) is mounted above. If people want to clean a bathroom or kitchen by spraying water, they have to store the water in the sink and then transfer water by ladle or other containers, so that usage of the faucet (50) is inconvenient and limited.

Therefore, the present invention has arisen to mitigate and/or obviate the drawbacks of the kitchen or bathroom faucets.

### SUMMARY OF THE INVENTION

The main objective of the present invention is to provide a connector for a faucet wherein the connector is rapidly detached from or combined with the faucet.

A further objective of the present invention is to provide a connector for a faucet wherein the connector is threadingly engaged with either a male thread or a female thread of a faucet.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a connector in accordance with the present invention;

FIG. 2 is an exploded perspective view of the connector with a faucet;

FIG. 3 is schematic view of the connector for the faucet showing that a hose nozzle is combined with the connector; and

FIG. 4 is an exploded perspective view of a prior art faucet with an aerator secured in a spout of the faucet.

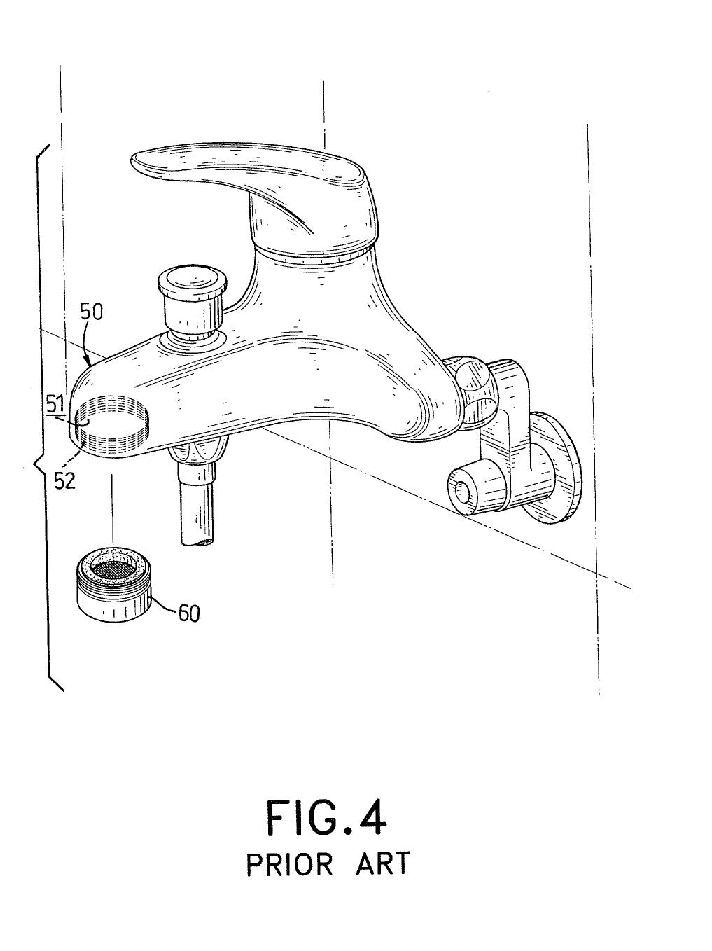

### DETAILED DESCRIPTION OF THE INVENTION

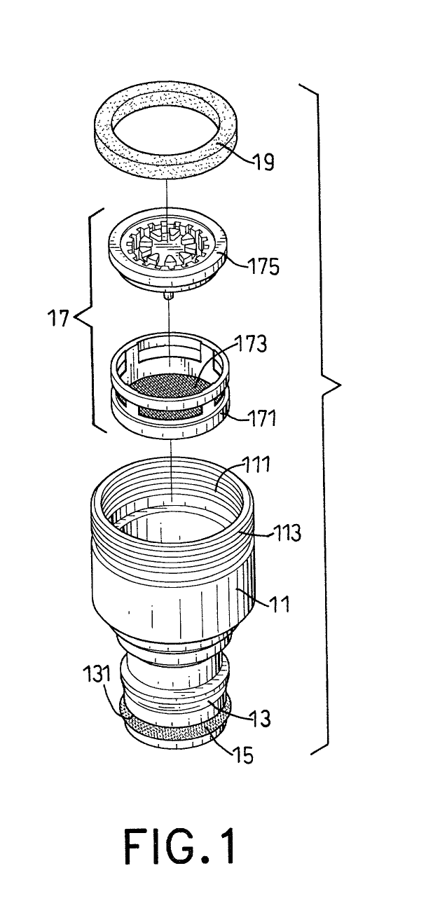

With reference to FIG. 1, a connector for a faucet is composed of an adaptor (10) and an aerator (17) secured inside the adaptor (10).

The adaptor (10) is a tube and has a faucet connecting portion (11) and a tube connecting portion (13) wherein the tube connecting portion has a smaller diameter than a diameter of the faucet connecting portion (11). An inner thread (111) is defined in an inner periphery of the adaptor (10) and an outer thread (113) is defined in an outer periphery of the adaptor (10). The tube connecting portion (13) is adapted to connect with a quick-release connector (not shown) and a trench (131) is defined in an outer periphery of the tube connecting portion (13). A gasket (15) is secured in the trench (131) of the tube connecting portion (13) to avoid water leaking therefrom.

The aerator (17) is secured in the faucet connecting portion (11) of the adaptor (10) and comprises a base (171), a screen (173) firmly constructed at a bottom face of the base (171), and a spoiler (175) mounted on the base (171). The spoiler (175) restricts the flow of water and simultaneously adds turbulence to the water to give the impression of a greater flow of water than there actually is. The screen (173) filters the water.

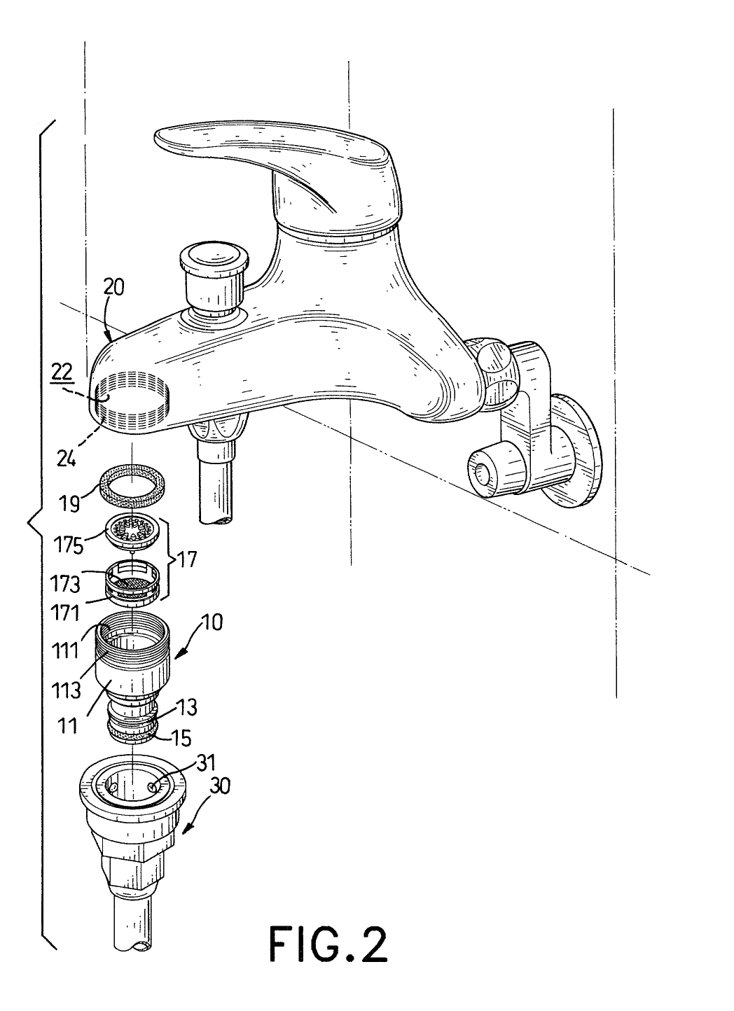

Additionally, a cushion (19) is mounted on the aerator (17) to avoid friction and water leakage between the aerator (17) and a faucet (20), as shown in FIG. 2, when the aerator (17) and the faucet (20) are combined together.

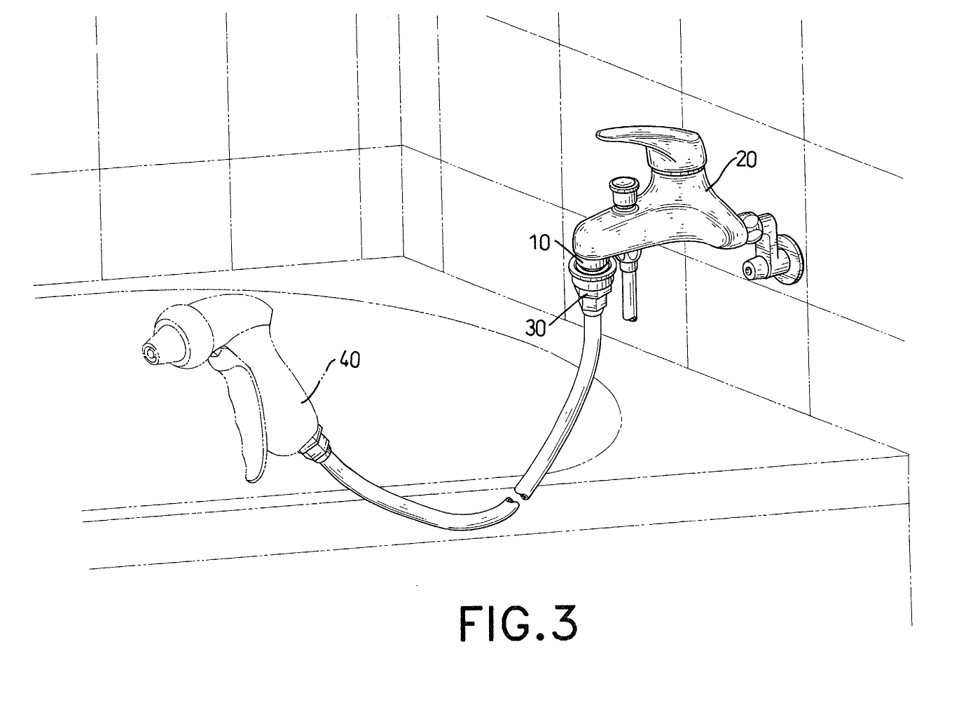

Now referring to FIGS. 2 and 3, to connect a nozzle (40) or other spraying devices to the faucet (20) via a quick-release hose (30), an original aerator (not shown) is detached from a spout (22) of the faucet (20). Then, the outer thread (113) of the adaptor (10) is firmly mated with a thread (24) of the faucet (20), wherein the thread (24) is already defined inside the faucet (20) for the original aerator so that users do not have to change the faucet (20) for connecting the connector (10). Afterwards, the quick-release hose (30) with the nozzle (40) is connected to the tube-connecting portion (13) of the connector (10) in a ball-spring combination (31) secured on an inner periphery of the quick-release hose (30). Therefore, the faucet (20) is communicated with the quick-release hose (30) by the connector (10) and water can be sprayed out from the faucet (20) to further places via the nozzle (40). Additionally, the gasket (15) mounted on the tube-connecting portion (13) prevents leaking from joints between the quick-release hose (30) and the connector (10).

For example, in a bathroom, the conventional aerator is detached from the faucet (20) and the connector (10) is secured to the faucet (20) by the thread (24) defined in the inner wall of the spout (22). Various spraying devices with the quick-release hoses (30) are able be mated with the faucet (20) in requirements to wash the bathroom. Therefore, the faucet (20) can supply water to further places than a sink or a bathtub and has great variety added to its original water-supplying function.

It is to be noted that the inner thread (111) on the inner periphery of the faucet-connecting portion (11) is adapted to combine with other faucets (20) that have the thread defined in an outer periphery of the spout (22). Therefore, the usage of the connector (10) is able to mate with more than one type of faucet.

Although the invention has been explained in relation to its preferred embodiment, it is to be understood that many other possible modifications and variations can be made without departing from the spirit and scope of the invention as hereinafter claimed.

What is claimed is:

1. A connector for a faucet that has a thread, the connector adapted to communicate with the faucet and comprising:
a faucet-connecting portion adapted to combine with the faucet and having an inner thread defined in an inner periphery of the faucet-connecting portion and an outer thread defined in an outer periphery of the faucet-connecting portion, wherein the faucet-connecting portion of the connector is threadingly collocate with the faucet;
a tube-connecting portion adapted to be combinable with a quick-release hose having a spraying device; and
an aerator secured inside the connector to regulate a flow of water from the faucet.

2. The connector for a faucet as claimed in claim 1, wherein the tube-connecting portion has a trench defined in an outer periphery of the tube-connecting portion and a gasket secured within the trench to avoid leaking between the connector and the quick-release hose.

3. The connector for a faucet as claimed in claim 1, wherein the tube-connecting portion has a diameter smaller than a diameter of the faucet-connecting portion.

4. The connector for a faucet as claimed in claim 2, wherein the tube-connecting portion has a diameter smaller than a diameter of the faucet-connecting portion.

5. The connector for a faucet as claimed in claim 1, wherein the aerator comprises
a base received in the faucet-connecting portion of the connector;
a screen firmly constructed in the base to filter the water; and
a spoiler mounted on the base to restrict a flow of water and simultaneously add turbulence to the water.

6. The connector for a faucet as claimed in claim 2, wherein the aerator comprises
a base received in the faucet-connecting portion of the connector; and
a screen firmly constructed in the base to filter the water; and
a spoiler mounted on the base to restrict a flow of water and simultaneously add turbulence to the water.

7. The connector for a faucet as claimed in claim 3, wherein the aerator comprises:
a base received in the faucet-connecting portion of the connector; and
a screen firmly constructed in the base to filter the water; and
a spoiler mounted on the base to restrict a flow of water and simultaneously add turbulence to the water.

8. The connector for a faucet as claimed in claim 1, in which a cushion is mounted on the aerator to avoid friction and leakage between the aerator and the faucet when the aerator and the faucet are combined together.

9. The connector for a faucet as claimed in claim 2, in which a cushion is mounted on the aerator to avoid friction and leakage between the aerator and the faucet when the aerator and the faucet are combined together.

10. The connector for a faucet as claimed in claim 3, in which a cushion is mounted on the aerator to avoid friction and leakage between the aerator and the faucet when the aerator and the faucet are combined together.

11. The connector for a faucet as claimed in claim 5, in which a cushion is mounted on the aerator to avoid friction and leakage between the aerator and the faucet when the aerator and the faucet are combined together.
